(19) United States
(12) Patent Application Publication
(10) Pub. No.: US 2022/0010060 A1
(43) Pub. Date: Jan. 13, 2022

(54) POLYCARBONATE POLYOLS

(71) Applicant: King Abdullah University of Science and Technology, Thuwal (SA)

(72) Inventors: Xiaoshuang FENG, Thuwal (SA); Naganath PATIL, Thuwal (SA); Senthil BOOPATHI, Thuwal (SA); Yves GNANOU, Thuwal (SA); Nikos HADJICHRISTIDIS, Thuwal (SA)

(21) Appl. No.: 17/413,030

(22) PCT Filed: Dec. 12, 2019
(86) PCT No.: PCT/IB2019/060737

§ 371 Date: Jun. 11, 2021

Related U.S. Application Data
(60) Provisional application No. 62/778,419, filed on Dec. 12, 2018.
(60) Provisional application No. 62/780,437, filed on Dec. 17, 2018.
(60) Provisional application No. 62/793,039, filed on Jan. 16, 2019.
(60) Provisional application No. 62/858,091, filed on Jun. 6, 2019.

(51) Int. Cl. C08G 64/34; C08J 11/02

(52) U.S. Cl. CPC C08G 64/34; C08J 2369/00; C08J 11/02

(57) ABSTRACT

Embodiments of the present disclosure describe polymerization systems for the synthesis of polycarbonate polyols, methods of synthesizing polycarbonate polyols using the polymerization systems, methods of recovering initiators and/or activators for use or re-use in the synthesis of polycarbonate polyol, and the like. The polymerization systems can comprise an initiator including a mono- or multi-functional carboxylate or carbonate salt having an organic cation as a counter-ion; an optional co-initiator including a mono- or multi-functional protic compound selected from acids, alcohols, water, and combinations thereof; and an activator including a borane compound selected from alkyl boranes and aryl boranes; wherein the activator and one or more of the initiator and co-initiator associate to form an ate complex.

### BACKGROUND

Polycarbonate diols and polycarbonate polyols of low molar masses are attracting interest as precursors in applications. For example, where used as precursors in polyurethane synthesis, the resulting polyurethanes exhibit better performance and reduce the carbon footprint when generated from polycarbonate polyol in comparison to polyether polyols or polyester polyols. To be suitable for such applications, polycarbonate polyols are required to exhibit well-defined terminal hydroxyl functionality, low polydispersity, and tunable carbonate contents.

While progress has been made in the preparation of polycarbonates of high molar mass and carbonate content, the preparation of low molar mass polycarbonate polyols with defined structures is still challenging. Where heterogeneous catalysts, such as double metal cyanide (DMC), are used to prepare polycarbonate diols, protic transfer agents such as alcohols and acids are required. Although the chain ends of such polycarbonate samples possess the expected hydroxyl functionality, they generally suffer from a low carbonate content, a lack of linear versus cyclic selectivity, and a broad polydispersity.

Polycarbonate polyols have also been prepared using homogeneous catalysts based on cobalt, zinc or magnesium. In these cases, the polycarbonate polyols possessed high carbonate content and narrow polydispersity, but, due to the association of anion with the metal center, the chain-end resulting from initiation by the nucleophile carried by the catalyst is blocked by a functional group other than hydroxyl and thus the polycarbonate polyols obtained are contaminated with mono-hydroxyl chains, undesirable for polyurethane applications. As clearly demonstrated in one report, polycarbonate tetrol and hexeol samples, prepared in the presence of tetra- and hexafunctional carboxylic acids, using tetraphenylporphyrinatocobalt (III) chloride as a catalyst, were contaminated with linear polycarbonates chains that had to be removed by fractionation. To address this issue, the ligand must be modified to be a polymerization initiator which carries multi-functional group.

Polycarbonate diols have also been obtained by another strategy to prepare a polycarbonate with a higher molar mass (80 to 100 kg/mol), followed by alcoholysis in the presence of “molecular” diols and an inorganic catalyst. These strategies require harsh conditions, which eventually afforded polycarbonate diol samples of broad molar mass distribution with cyclic by-products.

### SUMMARY

In general, embodiments of the present disclosure describe polymerization systems for the synthesis of polycarbonate polyols, methods of synthesizing polycarbonate polyols, methods of recovering and optionally recycling at least one of an initiator and activator for use or re-use in polycarbonate polyol synthesis, and the like.

Embodiments of the present disclosure describe a polymerization system for the synthesis of polycarbonate polyols comprising an initiator including a mono- or multi-functional carboxylate or carbonate salt having an organic cation as a counter-ion; an optional co-initiator including a mono- or multi-functional protic compound selected from acids, alcohols, water, and combinations thereof; and an activator including a borane compound selected from alkyl boranes and aryl boranes; wherein the activator and one or more of the initiator and co-initiator associate to form an ate complex.

Embodiments of the present disclosure describe a method of synthesizing a polycarbonate polyol comprising contacting an epoxide monomer and carbon dioxide in the presence of a polymerization system to form a crude polycarbonate product in solution; and precipitating a polycarbonate polyol product out of solution. In an embodiment, the polymerization system comprises an initiator including a mono- or multi-functional carboxylate or carbonate salt having an organic cation as a counter-ion; an optional co-initiator including a mono- or multi-functional protic compound selected from acids, alcohols, water, and combinations thereof; and an activator including a borane compound selected from alkyl boranes and aryl boranes.

Embodiments of the present disclosure describe a method of recovering and/or recycling an initiator for polycarbonate polyol synthesis comprising contacting a crude polycarbonate product having an activator-organic cation complex at a chain end with water to form an aqueous solution of an organic hydroxide; adding a neutralizing compound to the aqueous solution of the organic hydroxide to regenerate an initiator in the form of a carboxylate or carbonate salt of the organic cation; and separating the initiator from one or more of residual chemical species and solvents. In an embodiment, the method can further comprise recycling the recovered initiator for re-use in the synthesis of polycarbonate polyols.

Embodiments of the present disclosure describe a method of recovering and optionally recycling at least one of an activator and initiator from a solution for use or re-use in the synthesis of polycarbonate polyols, the method comprising one or more of the following steps: quenching a polymer solution containing a crude polycarbonate with a solution of a Lewis base and Lewis acid in water, said crude polycarbonate having an activator-organic cation complex at a chain end; reacting the organic cation with an anion to form an initiator that is extracted into a first layer; reacting the activator with a Lewis base to form an activator-Lewis base complex that is extracted into a second layer, said second layer being immiscible with said first layer; separating the first layer from the second layer; contacting the second layer with an isocyanate compound to disassociate the activator from the Lewis base and processing the second layer to recover the activator; contacting the first layer with a non-solvent to separate the initiator from the polymer and processing the first layer to recover the initiator; and recycling at least one of the initiator and activator.

The details of one or more examples are set forth in the description below. Other features, objects, and advantages will be apparent from the description and from the claims.

### BRIEF DESCRIPTION OF DRAWINGS

This written disclosure describes illustrative embodiments that are non-limiting and non-exhaustive. In the drawings, which are not necessarily drawn to scale, like numerals describe substantially similar components throughout the several views. Like numerals having different letter suffixes represent different instances of substantially similar components. The drawings illustrate generally, by way of example, but not by way of limitation, various embodiments discussed in the present document.

Reference is made to illustrative embodiments that are depicted in the figures, in which:

FIG. 1 is a flowchart of a method of synthesizing polycarbonate polyols, according to one or more embodiments of the present disclosure.

FIG. 2A is a flowchart of a method of recovering and/or recycling an initiator for polycarbonate polyol synthesis, according to one or more embodiments of the present disclosure.

FIG. 2B is a flowchart of a method of recovering and optionally recycling an activator and initiator from a solution for use or re-use in the synthesis of polycarbonate polyols, according to one or more embodiments of the present disclosure.

FIG. 3 is a flowchart of a process of polycarbonate separation and recycling of tetrabutylammnium carbonate (TBAC) initiator (if no cyclic carbonate produced during polymerization, step 6 is not needed), according to one or more embodiments of the present disclosure.

FIG. 4 shows representative gel permeation chromatography (GPC) traces for poly(propylene carbonate) (PPC) diol-1 (entry 4, Table 1) and PPC diol-2 (entry 5, Table 1) initiated from ammonium carboxylate, according to one or more embodiments of the present disclosure.

FIG. 5 shows representative GPC traces for PPC diol-3 (entry 7, Table 1), PPC diol-4 (entry 6, Table 1), and PPC diol-5 (entry 9, Table 1) initiated from tetrabutyl ammonium carbonate (TBAC), according to one or more embodiments of the present disclosure.

FIG. 6 shows representative GPC traces for PPC triol-1 (entry 13, Table 1), PPC triol (entry 14, Table 1) and PPC triol-3 (entry 15, Table 1) initiated from ATMA, according to one or more embodiments of the present disclosure.

FIG. 7 shows representative GPC traces for PPC tetraol-1 (entry 16, Table 1) and PPC tetraol-2 (entry 17, Table 1) initiated from APMA, according to one or more embodiments of the present disclosure.

FIG. 8 shows a 400 MHz ¹H NMR spectrum for entry 6 in CDCl₃ as representative example for PPC-diol, according to one or more embodiments of the present disclosure.

FIG. 9 shows a 400 MHz ¹H NMR spectrum for entry 13 in CDCl₃ as representative example for PPC-triol, according to one or more embodiments of the present disclosure.

FIG. 10 shows a 400 MHz ¹H NMR spectrum for entry 16 in CDCl₃ as representative example for PPC-tetraol. according to one or more embodiments of the present disclosure.

FIG. 11 shows a representative MALDI-TOF characterization results of PPC diol (entry 4, Table 1), according to one or more embodiments of the present disclosure.

FIG. 12 shows a representative MALDI-TOF characterization results of PPC diol (entry 6, Table 1), according to one or more embodiments of the present disclosure.

FIG. 13 shows a representative MALDI-TOF characterization results of PPC triol (entry 13, Table 1), according to one or more embodiments of the present disclosure.

FIG. 14 shows a representative MALDI-TOF characterization results of PPC tetraol (entry 16, Table 1), according to one or more embodiments of the present disclosure.

FIG. 15A shows a ¹H NMR spectrum of PPC-diol having 85% carbonate content (entry 2, Table 2), according to one or more embodiments of the present disclosure.

FIG. 15B shows a ¹H NMR spectrum of PPC-diol having 91% carbonate content (entry 6, Table 2), according to one or more embodiments of the present disclosure.

FIG. 15C shows a ¹H NMR spectrum of PPC-diol having 82% carbonate content (entry 10, Table 2), according to one or more embodiments of the present disclosure.

FIGS. 16A-16C shows representative FTIR spectra of PPC-diol samples displaying the selectivity between linear and cyclic carbonate: where (A) corresponds to entry 3 of Table 2; (B) corresponds to entry 6 of Table 2; and (C) corresponds to entry 10 of Table 2, according to one or more embodiments of the present disclosure.

FIGS. 17A-17F shows a representative GPC traces of PPC-diol samples from Table 2: where (A) corresponds to entry 1, (B) corresponds to entry 3, (C) corresponds to entry 4, (D) corresponds to entry 5, (E) corresponds to entry 9, and (F) corresponds to entry 10, according to one or more embodiments of the present disclosure.

FIG. 18 shows ¹¹B NMR evolution of triethylborane state during its recycling process, according to one or more embodiments of the present disclosure.

FIG. 19 shows a ¹H NMR characterization and quantification of recycled triethylborane using naphthalene as internal standard, according to one or more embodiments of the present disclosure.

### DETAILED DESCRIPTION

The present disclosure relates to polymerization systems for use in the synthesis of polycarbonate polyols and methods of synthesizing polycarbonate polyols. The polymerization systems comprise an initiator, an optional co-initiator, and an activator. In embodiments, an optionally metal-free initiator can include a carboxylate or carbonate salt of an organic cation, such as a mono- or multi-functional carboxylate or carbonate salt of tetrabutylammonium. The co-initiator can include a mono- or multi-functional protic compound, such as acids, alcohols (including phenols), water, and compounds including any two of those as functional groups. The activator can include a borane compound, such as an alkyl borane or aryl borane. The resulting polymerization systems can controllably and/or selectively activate epoxide monomers and carbon dioxide to copolymerize polycarbonate polyols with well-defined structures, low polydispersity, and tunable molar masses (e.g., 1,000 to 10,000 g/mol) and carbonate content. In addition, methods are provided in which at least one of an initiator and activator can be recovered and optionally recycled indefinitely for use or re-use in the synthesis of additional polycarbonate polyols.

As provided above, in embodiments, the polymerization systems can comprise an initiator, an optional co-initiator, and an activator. The initiator can include a mono- or multi-functional carboxylate or carbonate salt having an organic cation as a counter-ion. The optional co-initiator can include a mono- or multi-functional protic compound, wherein the mono- and multi-functional protic compound is selected from acids, alcohols, water, and combinations thereof. The activator can include a borane compound, wherein the borane compound is selected from alkyl boranes and aryl boranes. In embodiments, the activator and one or more of the initiator and co-initiator can associate to form an ate complex.

The initiators can include mono- and multi-functional carboxylate and carbonate salts having organic cations as counter-ions. These organic cations can be monomeric and polymeric attached to polymer or solid supporting materials as filed in WO2019220414A1. In one embodiment, the initiators can include mono- and multi-functional carboxylate and carbonate salts of tetrabutylammonium. Such initiators can be represented by general formula (I):

{R¹—[C(═O)O⁻]_{y}, [N⁺—(C₄H₉)₄]_{y}} (I)

wherein R¹ is selected from aliphatic hydrocarbons and aromatic hydrocarbons; and y ranges from 1 to n, preferably 1 to 4. The aliphatic and aromatic hydrocarbons are not particularly limited. For example, in an embodiment, the aliphatic and aromatic hydrocarbons can be selected from alkyls and aryls, either of which can be substituted or unsubstituted. The functionality of the mono- and multi-functional carboxylate salts of tetrabutylammonium initiators can relate to the value of y. For example, where y is 1, the initiator can be said to be mono-functional; where y is 2, the initiator can be said to be di-functional; where y is 3, the initiator can be said to be tri-functional; and where y is 4, the initiator can be said to be tetra-functional. In an embodiment, each carboxylate group has a tetrabutylammonium cation as a counter-ion.

Suitable aryls include monocyclic or polycyclic aromatic hydrocarbon radicals or moieties comprising carbon atoms that form an aromatic ring structure. In embodiments, the aryls can include more than one ring, in which case the rings may be fused or not fused, or bridged. In one embodiment, one or more alkyl groups can be attached to the aromatic rings. In another embodiment, the aryls can include heteroaryls in which at least one carbon atom in the aromatic ring is replaced with a heteroatom (e.g., N, O, S, or P). Non-limiting examples of suitable aryls include benzyl, phenyl, methylphenyl, dimethylphenyl, ethylphenyl, naphthyl, biphenyl, fluorenyl, indenyl, combinations thereof (e.g., aryls comprising one or more fused aromatic rings), and the like. Suitable alkyls include straight-or branched chain hydrocarbon radicals or moieties and cyclic hydrocarbon radicals or moieties. In one embodiment, the alkyls include heteroalkyls in which at least one carbon atom has been replaced with a heteroatom (e.g., N, O, S, or P). Non-limiting examples of suitable alkyls include methyl, ethyl, propyl, isopropyl, cyclopropyl, butyl, isobutyl, sec-butyl, tert-butyl, cyclobutyl, pentyl, neo-pentyl, cyclopentyl, hexyl, cyclohexyl, 2-ethylhexyl, cyclohexylmethyl, heptyl, octyl, nonyl, decyl, dodecyl, tridecyl, tetradcyl, pentadecyl, hexadecyl, heptadecyl, octadecyl, nonadecyl, cyclopentyl, cyclohexyl, cyclopropyl, cyclobutyl, cyclopentyl, cyclohexyl, cycloheptyl, cyclopentenyl, cyclohexenyl, cyclohexadienyl, cycloheptatrienyl, and the like.

In another embodiment, the initiators can include multi-functional carbonate salts of tetrabutylammonium. Such initiators can be represented by general formula (II):

{C(═O)(O⁻)_{y}, [N⁺—(C₄H₉)₄]_{y}} (II)

The carbonate salts of tetrabutylammonium initiators are typically di-functional initiators, where the value of each of y is 2. Although di-functional carbonate salts of tetrabutylammonium are provided as an example, it is possible for these initiators and derivatives thereof to have other functionalities.

In an embodiment, the mono- and multi-functional carboxylate and carbonate salts of tetrabutylammonium can be selected from:

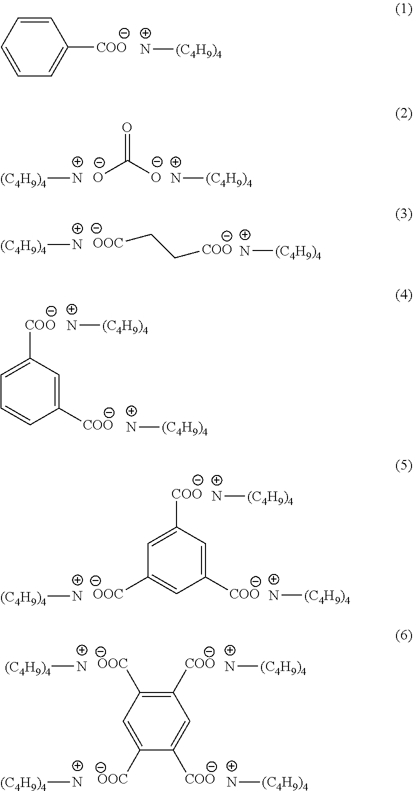

As shown above, chemical structure (1) can be said to be mono-functional; chemical structures (2) to (4) can be said to be di-functional; chemical structure (5) can be said to be tri-functional; and chemical structure (6) can be said to be tetra-functional. These are provided as examples and thus shall not be limiting.

While initiators including tetrabutylammonium cations have been described, other types of organic cations can also be used herein. Accordingly, in other embodiments, the initiators can generally include mono- and multi-functional carboxylate and carbonate salts having organic cations as counter-ions. Such initiators can be represented by general formulas (III) (carboxylate salts) and (IV) (carbonate salts):

{R¹—[C(═O)O⁻]_{y}, [X⁺]_{y}} (III)

{C(═O)(O⁻)_{y}, [X⁺]_{y}} (IV)

wherein R¹ is selected from aliphatic hydrocarbons and aromatic hydrocarbons (e.g., as described above); X⁺ is an organic cation; and y ranges from 1 to n, preferably 1 to 4. In these embodiments, the organic cation can be selected from ammoniums, phosphoniums, and phosphazeniums. For example, the organic cation can be based on phosphazene bases, such as t-Bu-Py, where Y is 2 or 4; as well as, ammonium salts and/or phosphonium salts, wherein the nitrogen or phosphorous thereof can be connected to four alkyl groups, each of which can be the same or different. For example, in one embodiment, the organic cations can be selected from NBu₄⁺, NPh₄⁺, NOct₄⁺, PBu₄⁺, PPh₄⁺, PPN⁺, t-BuP₄⁺, and t-BuP₂⁺.

The polymerization systems can optionally further comprise co-initiators including mono- and multi-functional protic compounds. The term “protic compounds” generally refers to any compound having a reactive hydrogen. The present disclosure may, in various instances, use the terms “co-initiator” and “protic compound” interchangeably herein. The selection of the protic compounds can be dependent upon the functionality of the initiator used. For example, in an embodiment, the functionality of the protic compound is or shall be the same as the functionality of the initiator. Suitable protic compounds can generally include aliphatic or aromatic acids and alcohols (including phenols), and water. In addition, protic compounds containing at least two of those as functional groups, such as compounds formed from the combination of an acid and phenol, can also be used. Examples of such functional groups can include, but are not limited to, —OH, —SH, —C(O)OH, and —NH. In one embodiment, the protic compound can be selected from sulfonic acids, carboxylic acids, adducts of boric acid, glycols, salicylic acids, alcohols, phenols, and water. Others are known in the art and thus these shall not be limiting.

The activator can comprise a borane compound. The borane compound can be selected from alkyl boranes and aryl boranes. For example, in an embodiment, the borane compound is a trialkyl borane or a triaryl borane. The trialkyl and triaryl boranes can be represented by general formula (V):

B(R²)₃ (V)

wherein each R² is independently selected from alkyls and aryls, wherein the alkyls are selected from linear or branched alkyl groups, aromatic or non-aromatic alkyl groups, and carbocyclic or heterocyclic alkyl groups, each of which can be substituted or unsubstituted;
wherein the aryls are selected from aryl groups and heteroaryl groups, each of which can be substituted or unsubstituted. Suitable alkyls and aryls include those described above. For example, in an embodiment, each R² is selected from an ethyl, n-butyl, i-butyl, n-octyl, and phenyl group to provide triethyl borane, tributyl borane, triisobutyl borane, trioctyl borane, and triphenyl borane as the borane compound, respectively. In one embodiment, the borane compound is triethyl borane.

In embodiments, the borane compound can react with the initiator, protic compound, or both, under stoichiometric conditions, to form an ate complex. The ate complex can be used to initiate the polymerization of epoxides and carbon dioxide. For example, in an embodiment, the ate complex can be used to activate the carbon dioxide. In some embodiments, the ate complex may not be sufficiently nucleophilic to activate the epoxide. In these embodiments, the borane compound can be effective to activate the epoxide monomer and thus can be used for such purposes. Since the borane compound typically reacts under stoichiometric conditions with the initiator, protic compound, or both in forming the ate complex, the borane compound can be provided in excess to ensure activation of the epoxide monomer. For example, in some embodiments, without an excess of the borane compound, the polymerization may not occur. It thus can be important to provide the borane compound in excess of one or more of the initiator and protic compound.

The molar ratio of the borane compound to the initiator to the protic compound can generally be represented by the following formula: X (borane compound):Y (initiator): Z (protic compound), wherein each of X, Y, and Z can range from about 0.01 to about 10, or greater. In some embodiments, the borane compound is provided in molar excess of the initiator and/or the protic compound (if present); and the initiator is provided in molar excess of the protic compound. For example, in an embodiment, the molar ratio of the borane compound to the initiator to the protic compound can be about 1.01:1:0.1, about 2:1:0, about 3:1:0, about 4:1:0, about 5:1:0, about 6:1:0, about 7:1:0, about 8:1:0, about 9:1:0, about 10:1:0.9, or any increment thereof. In one embodiment, the molar ratio of the borane compound to the initiator to the protic compound can be about 2:1:0, about 2.2:1:0.3, about 2:1.3:0, about 2.8:1:0, about 3:1:0, about 3.5:1:0, about 3.5:0.7:0.3, about 3.6:1:0, about 4:1:0, about 5:1:0, about 5:0.7:0.3, about 5:0.8:0.2, or any increment thereof. These shall not be limiting as other ratios are within the scope of the present disclosure.

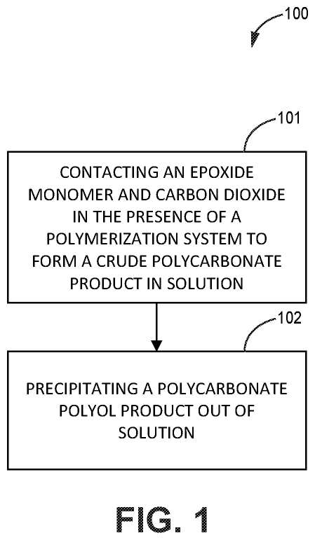

FIG. 1 is a flowchart of a method for preparing polycarbonate polyols, according to one or more embodiments of the present disclosure. As shown in FIG. 1, the method can comprise contacting 101 an epoxide monomer and carbon dioxide in the presence of a polymerization system to form a crude polycarbonate product in solution; and precipitating 102 a polycarbonate polyol product out of solution. The polymerization systems can include any of the polymerizations systems of the present disclosure. For example, in an embodiment, the polymerization systems can include an initiator, co-initiator or protic compound, and activator. In one embodiment, the polymerization system comprises an activator including a borane compound, an initiator including a mono- or multi-functional carboxylate or carbonate salt of an organic cation (e.g., tetrabutylammonium), and optionally a co-initiator or a protic compound.

At step 101, the epoxide monomer, carbon dioxide, and polymerization system are brought into physical contact, or at least immediate or close proximity For example, in an embodiment, the initiator, activator, optional protic compound, and solvent can be contacted in a reaction medium to prepare, or form, the polymerization system. Upon preparing/forming the polymerization system, the polymerization system can be contacted with the epoxide monomer in the reaction medium and the reaction medium can be charged with carbon dioxide. This is provided as just one example, as the manner in which the contacting is performed is not particularly limited. In other embodiments, for example, the contacting can proceed sequentially in any order, or simultaneously. The conditions under which the contacting is performed are also not particularly limited. For example, the contacting can proceed to or at one or more temperatures and one or more pressures. The one or more temperatures can range from about room temperature to about 100° C., or any incremental value or range thereof, among other temperatures. The one or more pressures can range from about 1 bar to about 50 bar, or any incremental value or range thereof, among other pressures.

The epoxide monomer can be substituted or unsubstituted and functionalized or non-functionalized. In an embodiment, the epoxide monomer can be represented by the general structure below:

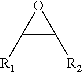

wherein each of R₁ and R₂ can be independently selected from hydrogen, alkyls, heteroalkyls, cycloalkyls, alkenyls, heteroalkenyls, cycloalkenes, alkynyls, heteroalkynyls, cycloalkynyls, alkoxys, aryls, heteroaryls, aralkyls, aralkylenes, alkaryls, alkarylenes, halogens, or combinations thereof, each of which can be substituted or unsubstituted. For example, the epoxide monomer can be selected from the following structures:

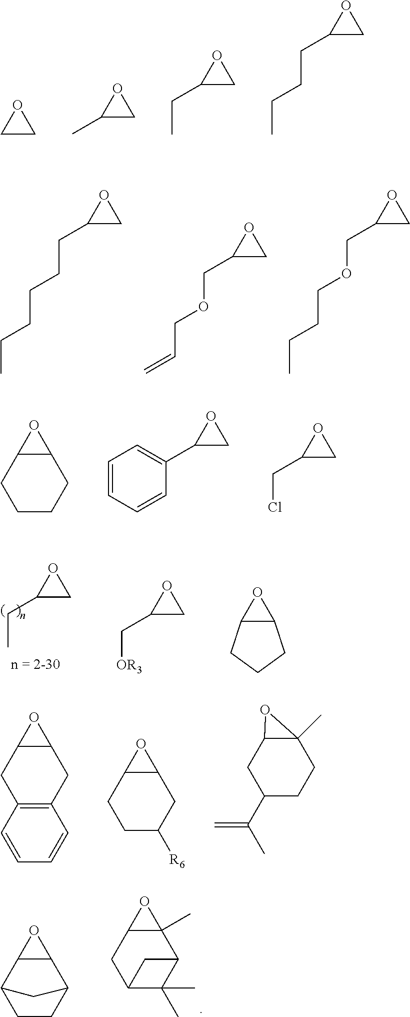

The solution, which contains the crude polycarbonate product and usually at least some residual or other chemical species and solvent, can be subjected to a step 102 in which a polycarbonate polyol produce is precipitated out of solution. The precipitating step can be useful in embodiments in which the crude polycarbonate product includes polycarbonates having an activator-organic cation complex at chain ends. The precipitating can thus be performed to remove the activator-organic cation complex from the crude polycarbonate product, separate off any residual chemical species and solvents, and/or obtain the polycarbonate polyol product. In some embodiments, the precipitating can include additional steps. For example, in an embodiment, the precipitating can include one or more of precipitating a crude polycarbonate polyol product in water, centrifuging the resulting aqueous solution, separating the aqueous layer from the centrifuged solution, diluting the solution with an organic solvent, and precipitating the polycarbonate polyol product in acidic water. The organic solvents and acidic water are not particularly limited and can include, for example, THF and aqueous HCl, among others. In addition to these processing step(s), the processing can also be performed according to conventional processes known in the art and thus are not particularly limited.

The resulting polycarbonate polyol product can have a well-defined structure and narrow polydispersity, with tunable and/or controllable molar masses and carbonate content. In an embodiment, the polycarbonate polyol product can be represented by the following generic chemical structure: R—[(CHR₁CHR₂OCO—)ₓ—(CHR₁CHR₂O—)_{y}]ₙH.

In embodiments, the polydispersity can be in the range of about 1 to about 2. The range includes any value between 1 and 2 and any incremental range between 1 and 2. In certain embodiments, the polydispersity can be about 1.5 or less. In certain embodiments, the polydispersity can be about 1.4 or less. In certain embodiments, the polydispersity can be about 1.3 or less. In certain embodiments, the polydispersity can be about 1.2 or less. In certain embodiments, the polydispersity can be about 1.1 or less. In certain embodiments, the polydispersity can be about 1.0.

The molar mass and/or carbonate content of the polycarbonate polyol product can be tuned by varying one or more of the feeding ratio of epoxide monomer to the initiator, borane compound to the initiator, and charging pressure of the carbon dioxide. For example, in an embodiment, the molar ratio of the borane compound to the initiator to the protic compound can generally be represented by the following formula: W (epoxide monomer):X (borane compound):Y (initiator): Z (protic compound), wherein each of W, X, Y, and Z can range from about 0.01 to about 1000, or greater. The charging pressure of carbon dioxide is not particularly limited and can range from, for example, about 0.01 bar to about 50 bar, among other pressures. In embodiments, the carbonate content can be in the range of 1% to about 99% or greater, or any value or incremental range between 1% and 99%. In embodiments, the molar mass of the polycarbonate polyol molar mass can be in the range of about 100 g/mol to about 100,000 g/mol, or any value or incremental range between 100 g/mol and 100,000 g/mol. For example, in certain embodiments, the molar mass is in the range of about 1,000 g/mol to about 10,000 g/mol.

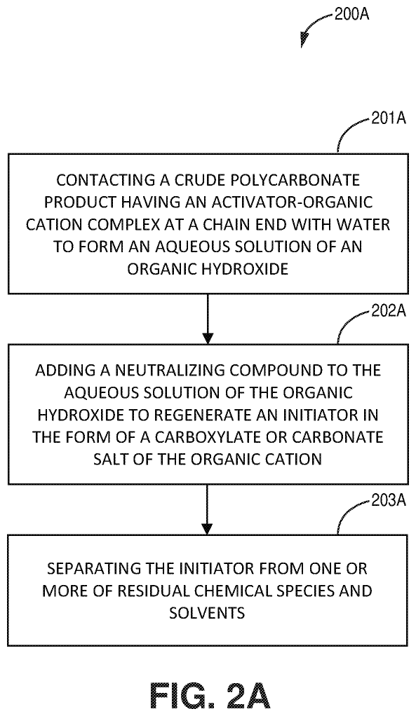

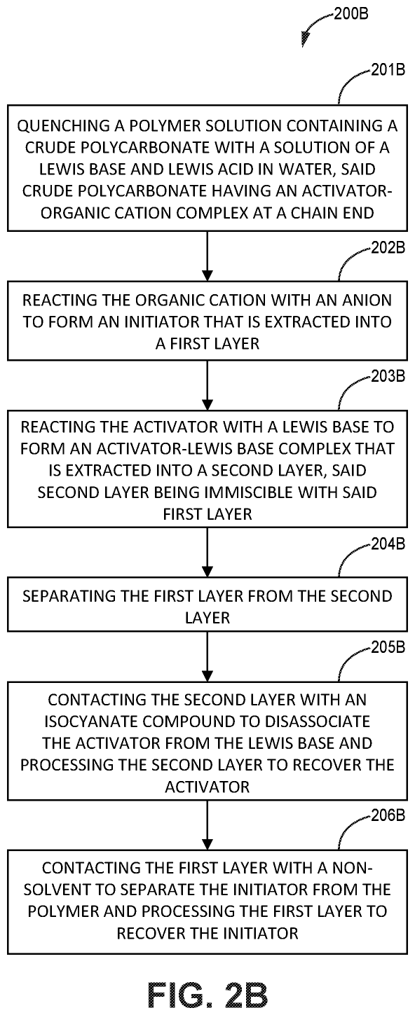

FIG. 2A is a flowchart of a method of recovering and/or recycling an initiator for re-use in polycarbonate polyol synthesis, according to one or more embodiments of the present disclosure. As shown in FIG. 2A, the method 200A of recovering and/or recycling an initiator for polycarbonate polyol synthesis can comprise contacting 201A a crude polycarbonate product having an activator-organic cation complex at a chain end with water to form an aqueous solution of an organic hydroxide; adding 202A a neutralizing compound to the aqueous solution of the organic hydroxide to regenerate an initiator in the form of a carboxylate or carbonate salt of the organic cation; and separating 203A the initiator from one or more of residual chemical species and solvents. In an embodiment, the method 200A can further comprise recycling the recovered initiator for re-use in the synthesis of additional polycarbonate polyols.

The step 201A can include contacting a crude polycarbonate product having an activator-organic cation complex at a chain end with water to form an aqueous solution of an organic hydroxide. In some embodiments, this step can be performed after contacting an epoxide monomer and carbon dioxide in the presence of a polymerization system (e.g., as in step 101). The aqueous solution can optionally further comprise one or more of residual chemical species (e.g., reagents, reaction participants, etc.), side- or by-products (e.g., cyclic carbonates, etc.), and solvents. Since the chain end of the crude polycarbonate product has an activator-organic cation complex, it can be desirable to form an organic hydroxide from the organic cation to aid in recovering the initiator. While not wishing to be bound to a theory, it is believed that, by contacting in this way, the crude polycarbonate product carrying the organic cation at the chain end undergoes hydrolysis to form the organic hydroxide, which can dissolve in the aqueous layer and also leave behind a crude polycarbonate product or, in some instances, a crude polycarbonate polyol product, as a precipitate. Accordingly, the contacting is sufficient to convert the organic cation into an organic hydroxide, which can be used to regenerate the initiator.

The contacting 201A typically proceeds by bringing at least the crude polycarbonate product and water into physical contact, or immediate or close proximity In an embodiment, the contacting can include or proceed under stiffing. The conditions under which the contacting proceeds are not particularly limited. For example, moderate temperatures and pressures can be suitable, among others. The crude polycarbonate product can be formed according to any of the methods of the present disclosure (e.g., by performing step 101). In addition, any of the activators and organic cations of the present disclosure can be provided at the chain end; and the organic hydroxide can be formed from any of the organic cations of the present disclosure. For example, the organic hydroxide can include ammonium hydroxides, phosphonium hydroxides, and phosphazenium hydroxides. In one embodiment, the organic hydroxide is tetrabutylammonium hydroxide. The organic hydroxide will typically dissolve in the aqueous solution.

The step 202A can include adding a neutralizing compound to the aqueous solution of the organic hydroxide to regenerate an initiator in the form of a carboxylate or carbonate salt of the organic cation. The adding is similar to, or at least one example of a form of, contacting, and thus can be performed in the same or similar manner, among other ways. The neutralizing compound employed should be sufficient to transfer or convert the organic hydroxide to carboxylate or carbonate salts of the organic cation. For example, in an embodiment, the neutralizing compound is carbon dioxide. In an embodiment, the adding can proceed by bubbling carbon dioxide through the aqueous solution of the organic hydroxide. In this way, the solution can be neutralized and the initiator can be regenerated in the form of a carbonate salt having an organic cation as the counter-ion. In an embodiment, the adding can proceed by contacting a carboxylate acid with the aqueous solution of the organic hydroxide. In an embodiment, the carboxylic acids are added into the aqueous solution of the organic hydroxide to neutralize. In this way, the solution can similarly be neutralized and the initiator can be regenerated in the form of a carboxylate salt having an organic cation as the counter-ion, with a functionality dependent upon the selection of the carboxylic acid.

The step of 203A is optional and includes separating the initiator from the other chemical species and solvents. The initiator can typically be regenerated in a solution that can also include side products, solvents, and/or other chemical or residual species. For example, the side products can include cyclic carbonates, among others. The solvents can include water and organic solvents, among others. Accordingly, it can be desirable to separate the initiator from these other chemical species and solvents in order to recover and/or recycle it for reuse in the synthesis of polycarbonate polyols. The manner in which the separating step 203 is performed is not particularly limited and can include, for example, drying and/or washing to separate or remove one or more of solvents and side products, among other things. The drying can be performed by evaporation, lyophilization, and other methods of drying known in the art. The washing can be performed by contacting with a solvent. In one embodiment, the separating can include drying the solution containing the initiator by evaporation to remove water and organic solvent and optionally washing with a solvent (e.g., toluene) to remove a cyclic carbonate side product. In embodiments in which the cyclic carbonate side product is not present, the washing step does not need to be performed.

The recovery of the initiator can be described in terms of the percentage recovered relative to the amount used originally to initiate the polymerization of polycarbonate polyols. The methods described herein are capable of consistently and repeatedly recovering an unprecedented 100% of the initiator used originally in the polymerization of the polycarbonate polyol. A fully recovery of the initiator can be achieved over the course of an indefinite number of polymerization reactions (e.g., in perpetuity). Accordingly, the initiators can be used, recovered, and recycled, in batch and/or continuous processes for the synthesis of polycarbonate polyols, providing scalability and commercial access thereto.

While the initiator can be fully recovered (e.g., 100% recovery), in some embodiments, the recovery of the initiator can be less than full recovery. For example, the recovery of the initiator can be about 100% or less, 99.9% or less, 99% or less, 98% or less, 97% or less, 96% or less, 95% or less, 90% or less, or any increment ranging from between about 0.01% to about 100%. In an embodiment, at least 90% of the initiator is recovered. In an embodiment, the initiator is fully recovered. In an embodiment, the method 200 further comprises recycling the recovered initiator for use in the synthesis of polycarbonate polyols.

FIG. 2B is a flowchart of a method of recovering and optionally recycling at least one of an activator and initiator from a solution for use or re-use in the synthesis of polycarbonate polyols, according to one or more embodiments of the present disclosure. The method 200B can comprise one or more of the following steps: quenching 201B a polymer solution containing a crude polycarbonate with a solution comprising a Lewis base and Lewis acid in water, said crude polycarbonate having an activator-organic cation complex at a chain end; reacting 202B the organic cation with an anion to form an initiator that is extracted into a first layer; reacting 203B the activator with a Lewis base to form an activator-Lewis base complex that is extracted into a second layer, said second layer being immiscible with said first layer; separating 204B the first layer from the second layer; contacting 205B the second layer with an isocyanate compound to disassociate the activator from the Lewis base and processing the second layer to recover the activator; and contacting 206B the first layer with a non-solvent to separate the initiator from the polymer and processing the first layer to recover the initiator. In certain embodiments, the method 200B can proceed metal-free and thus is capable of proceeding in the absence of or without any metals or metal-containing compounds. In certain embodiments, the method 200B further comprises recycling (not shown) at least one of the initiator and activator (e.g., such as those recovered from steps 205B and/or 206B).

Step 201B includes quenching a polymer solution containing a crude polycarbonate with a solution comprising a Lewis base and Lewis acid in water. To perform the quenching 201B, the polymer solution can be contacted with said solution. Mixing, stiffing, and the like can also be performed to facilitate the quenching process. Suitable crude polycarbonates will have an activator-organic cation complex at a chain end. Polymer solutions containing such crude polycarbonates can be obtained from any source. In certain embodiments, polymer solutions obtained in accordance with the method shown in FIG. 1 are used. For example, step 201B can be performed after the contacting step 101 wherein the epoxide monomer and carbon dioxide are contacted in the presence of the polymerization system. Step 201B can also be formed after the step 102. In certain embodiments, the quenching step 201B can give rise to or bring about various reactions that result in the removal of the activator-organic cation complex from the chain end of the crude polycarbonate and/or precipitation of the crude polycarbonate. For example, in some embodiments, the quenching step 201B can perform or include steps 202B, 203B, 206B, or combinations thereof.

Suitable Lewis bases include primary amines and secondary amines. The primary and secondary amine may be selected based on each amine's ability to complex with the activator from the polymer chain end. In certain embodiments, the Lewis base is selected from primary and secondary amines comprising alkyl substituents, wherein the alkyl substituents can comprise 30 or fewer carbon atoms, preferably 12 or fewer carbon atoms, more preferably 6 or fewer carbon atoms. Examples of alkyl substituents include, but are not limited to, methyl, ethyl, propyl, isopropyl, cyclopropyl, butyl, isobutyl, sec-butyl, tert-butyl, cyclobutyl, pentyl, neo-pentyl, cyclopentyl, hexyl, cyclohexyl, 2-ethylhexyl, cyclohexylmethyl, heptyl, octyl, nonyl, decyl, dodecyl, tridecyl, tetradcyl, pentadecyl, hexadecyl, heptadecyl, octadecyl, nonadecyl, cyclopentyl, cyclohexyl, cyclobutyl, cyclopentyl, cyclohexyl, cycloheptyl, cyclopentenyl, cyclohexenyl, cyclohexadienyl, and the like. In certain embodiments, the alkyl substituents are selected from methyl, ethyl, propyl, isopropyl, butyl, iso-butyl, sec-butyl, t-butyl, pentyl, and hexyl. For example, in certain embodiments, the Lewis bases are selected from butylamine, pentylamine, hexylamine, diethylamine, dipropylamine, and dibutylamine.

Suitable Lewis acids include acids comprising a hydroxide, carboxylate, carbonate, alkoxide, phenoxide, and/or halide. The Lewis acid can be selected based on its ability to quench the polymer solution (e.g., by protonating polymer chain ends) either by itself or in combination with water (e.g., as a quenching agent composed of water and Lewis acid with, e.g., a pH of 6 or less), and/or its ability to generate an anion capable of reacting with the organic cation from the polymer chain end. While inorganic acids or acids comprising metals can be utilized herein and thus are within the scope of the present invention, preferred Lewis acids are metal-free. For example, organic acids or organic compounds comprising a hydroxide, carboxylate, carbonate, alkoxide, phenoxide, and/or halide, may be preferred. In certain embodiments, the Lewis acid is selected from water, carbon dioxide, carboxylic acids such as carboxylic acids of the formula RCOOH, alcohols such as alcohols of the formula ROH, phenols, carbonate compounds, and halogen compounds such as halogen compounds of the formula HX, where R is any hydrocarbon and X is any halide.

Non-limiting examples of Lewis acids include water; carbon dioxide; alcohols, such as methanol, ethanol, propanol, butanol, hexanol, benzyl alcohol, and the like; carboxylic acids, such as formic acid, acetic acid, propionic acid, butyric acid, valeric acid, caproic acid, pentanoic acid, caprylic acid, pelargonic, carbonic acid, oxalic acid, malonic acid, succinic acid, glutaric acid, adipic acid, p-Mer acid, suberic acid, azelaic acid, sebacic acid, methyl succinic acid, 2,2-dimethyl succinic acid, 2,3-dimethylsuccinic acid, methylmalonic acid, α-methyl glutaric acid, β-methyl glutaric acid, 2,2-dimethyl glutaric acid, 2,4-dimethyl glutaric acid, 3,3-dimethyl glutaric acid, 2-ethyl-2-methyl succinic acid, 2,2,5,5-tetramethyl-hexanoic acid, 3-methyl adipic acid, acrylic acid, crotonic acid, isocrotonic acid, vinyl acetate, methacrylic acid, fumaric acid, maleic acid, methyl maleic acid, methyl fumaric acid, itaconic acid, citraconic acid, mesaconic acid, glutaconic acid, non-acid, 2-methyl-non-acid, acetylene dicarboxylic acid, oxalic acid, malonic acid, succinic acid, glutaric acid, adipic acid, pimelic acid, suberic acid, azelaic acid, sebacic acid, undecanedioic acid, dodecanedioic acid, 1-propyn-1,3-dicarboxylic acid, methane tricarboxylic acid, ethylene tricarboxylic acid, citric acid, isocitric acid, aconitic acid, propane-1,2,3-tricarboxylic acid, trimesic acid, cyclohexanecarboxylic acid, kolran acid, lithocholic acid, cholic acid, 1,2-cyclohexanedicarboxylic acid, 1,3-cyclohexanedicarboxylic acid, 1,4-cyclohexanedicarboxylic acid, 3,3-tetramethylene glutaric acid, benzoic acid, toluic acid, kumsan, phthalic acid, isophthalic acid, terephthalic acid, and the like; carbonate compounds, such as carbonic acid, organic carbonates, such as carbonate esters, derivatives thereof, and the like; phenol and derivatives thereof; and halogen compounds, such as HCl, HBr, HI, HF, and the like.

At step 202B, the organic cation is reacted with an anion to form an initiator. While the organic cations and anions are generally not particularly limited, it is preferred to use organic cations and anions that react to form the initiators of the present invention. For example, the organic cations can include, but are not limited to, NBu₄⁺, NOct₄⁺, NPh₄⁺, PBu₄⁺, PPh₄⁺, PPN⁺, t-BuP₄⁺, t-BuP₂⁺, and the like. Non-limiting examples of the anions include hydroxides, carboxylates, carbonates, alkoxides, phenoxides, halides, and the like. In some embodiments, the anions can originate from one or more of the components the solution from step 201B. For example, in one embodiment, the anions can originate from the Lewis acid or water, or both. In other embodiments, an anion source can be separately added to the polymer solution in this step to provide the anions that react with the organic cation to form the initiator. Once formed, the initiator can be extracted into the first layer or, in the alternative, it can continue to reside in the first layer.

At step 203B, the activator is reacted with the Lewis base to form an activator-Lewis base complex. The activator can include any of the borane compounds disclosed herein. For example, in certain embodiments, the activator can be selected from alkyl boranes and aryl boranes, such as triethyl borane, tributyl borane, triisobutyl borane, trioctyl borane, triphenyl borane, and the like. As described above, the Lewis base can be selected from primary amines and secondary amines. Examples of suitable Lewis bases include, but are not limited to, butylamine, pentylamine, hexylamine, diethylamine, dipropylamine, dibutylamine, and the like. In certain embodiments, the activator-Lewis base complex is an adduct of the activator and Lewis base. Once formed, the activator-Lewis base complex can be extracted into the second layer or, in the alternative, it can continue to reside in the second layer.

At step 204B, the first layer is separated from the second layer. The second layer containing the activator-Lewis base complex comprises a liquid phase (e.g., solvent or other liquid) that is immiscible or substantially immiscible with the liquid phase of the first layer and thus can be readily separated. Preferably the initiator is soluble in the liquid phase of the first layer and the activator-Lewis base complex is soluble in the liquid phase of the second layer. However, embodiments include initiators which are soluble in the liquid phase of the second layer and activator-Lewis base complexes which are soluble in the liquid phase of the first layer. While either of the first layer and the second layer can comprise or constitute an aqueous layer, and either can comprise or constitute an organic layer, in certain embodiments, the first layer is an aqueous layer and the second layer is an organic layer.

Upon separating the first and second layers, each can be processed to isolate and recover, and in some instances, regenerate, the initiator and activator for use or re-use in the synthesis of additional polycarbonate polyols. At step 205B, the second layer is contacted with an isocyanate compound to disassociate (or deblock) the activator from the Lewis base, thereby regenerating the activator. Once deblocked, the second layer or the freed activator can be subjected to further processing to isolate and/or recover the activator. The processing can include any processes suitable for removing solvents and chemical species to isolate, separate, and/or recover the activator. For example, in certain embodiments, the processing can include performing, one or more times, any of the following: distillation, drying, washing, dissolving, combinations thereof, and the like. For example, in one embodiment, the processing can include dissolving the distillation residue (e.g., a residue comprising the activator-Lewis base complex, the activator, or combinations thereof), subjecting to distillation, and redissolving the distillation residue. These steps or any one of these steps can be performed one or more times until the activator is sufficiently isolated to permit recovery thereof. Other examples of the processing include evaporation, filtration, and drying, among others. The activator can be partially or fully recovered. For example, in embodiments, the percent recovered of the activator can be up to about 100%, or any value between 0% and 100%.

Suitable isocyanate compounds include, but are not limited to, tosyl isocyanate, methyl isocyanate, ethyl isocyanate, n-propyl isocyanate, n-butyl isocyanate, t-butyl isocyanate, hexyl isocyanate, octyl isocyanate, dodecyl isocyanate, octadecyl isocyanate, hexadecyl isocyanate, cyclohexyl isocyanate, phenyl isocyanate, diphenylmethane diisocyanate, isophorone diisocyanate, toluene diisocyanate, hexamethylene diisocyanate, tetramethylxylene diisocyanate, p-phenylene diisocyanate, hydrogenated diphenylmethane diisocyanate, toluene diisocyanate, sulfonated diphenylmethanediisocyanate, m-phenylene diisocyanate, phenyl isocyanate, 2,4,-toluylene diisocyanate, 2,6-toluylene diisocyanate, toluyl isocyanate, 3,3′-dimethyl, 4,4′-biphenylene, diisocyanate, 3,3 dimethoxy-4,4′ biphenylene diisocyanate, 3,3 diphenyl-4,4′-biphenylene diisocyanate, 1-trichloro methyl-2,4-diisocyanato benzene, 2-isocyanato diphenyl ether, diphenyl sulfone-4-isocyanate, 3-isocyanato-acetophenone, diphenyl methane-4,4′-diisocyanate, di-phenyl-4,4′-diiso cyanate, naphthalene-1,5-diisocyanate, triphenyl meth-3-ane-4,4′,″-triisocyanate, 4,4-diisocyanato diphenyl sulfone, combinations thereof, and the like.

At step 206B, the first layer is contacted with a non-solvent to separate the initiator from the polycarbonate polyol. In this step, the non-solvent is used to precipitate the crude polycarbonate present in the first layer. The nature and solubility of the crude polycarbonate and/or polycarbonate polyol can inform the selection of non-polar versus polar non-solvents and protic vs. aprotic non-solvents. Although not a requirement, non-solvents with relatively low boiling points can be selected to facilitate the processing performed in this step. While also not a requirement, the non-solvents can be selected to be miscible with the liquid phase of the first layer. Non-limiting examples of non-solvents can include hexane, water, carbon tetrachloride, benzene, diethyl ether, methylene chloride, toluene, pentane, petroleum ether, cyclohexane, carbon tetrachloride, xylene, diethyl ether, chloroform dichloromethane, tetrahydrofuran, dichloroethane, acetone, dioxane, ethylacetate, dimethylsulfoxide, aniline, diethylamine, acetonitrile, pyridine, isopropanol, ethanol, methanol, ethylene glycol, acetic acid, methyl chloride, chloroethane, trichloroethane, trichlorethylene, tetrachloroethane, chlorobenzene, dichlorobenzene, methyl acetate and ethyl acetate, methyl ethyl ketone, and the like.

By precipitating the crude polycarbonate, the polycarbonate polyol can be readily separated or removed from the first layer which can be processed to isolate and recover the initiator. The processing can include any processes suitable for removing solvents and/or chemical species other than the initiator. For example, in certain embodiments, the processing includes solvent removal, filtration, drying (e.g., by evaporation, lyophilization, etc.), washing, and the like, any of which can be repeated one or more times. In some embodiments, this step can include one or more of the steps presented in FIG. 2A. The initiators recovered in this step can include, for example, any of the initiators of the present invention, such as those comprising a carboxylate or carbonate salt having the organic cation as counter-ion. The initiator can be partially or fully recovered. For example, in embodiments, the percent recovered of the initiator can be up to about 100%, or any value between 0% and 100%.

While FIG. 2B shows steps 201B to 206B, the method 200B does not require each of those steps and thus can comprise any one or more of the steps 201B to 206B. In addition, the method 200B need not proceed in any particular order. Non-limiting examples of various combinations of the steps 201B to 206B are provided below:

In certain embodiments, a method of recovering an activator for use or re-use in the synthesis polycarbonate polyols is provided, said method comprising one or more of the following steps: providing a polymer solution containing a crude polycarbonate, said crude polycarbonate having an activator-organic cation complex at a chain end; reacting the activator with a Lewis base to form an activator-Lewis base complex that is extracted into an organic layer; contacting the organic layer with an isocyanate compound to disassociate the activator from the Lewis base; and processing the second layer to recover the activator.

In certain embodiments, a method of recovering an initiator for use or re-use in the synthesis of polycarbonate polyols is provided, said method comprising one or more of the following steps: providing a polymer solution containing a crude polycarbonate, said crude polycarbonate having an activator-organic cation complex at a chain end; reacting the organic cation with an anion to form an initiator compound that is extracted into an aqueous layer; and processing the first layer to recover the initiator.

The following Examples are intended to illustrate the above invention and should not be construed as to narrow its scope. One skilled in the art will readily recognize that the Examiners suggest many other ways in which the invention could be practiced. It should be understand that numerous variations and modifications may be made while remaining within the scope of the invention.

### EXAMPLE 1

### Mechanism for Ammonium-Carboxylate Initiated Copolymerization of Epoxides and CO₂

The following Example relates to the copolymerization of epoxides and CO₂ to form polycarbonate diols and polyols. The preparation of the polycarbonate diols and polyols were initiated with carboxylate salts of tetrabutylammonium having a functionality ranging from 1 to 4. Scheme 1 provided below is a schematic representation of a proposed mechanism for ammonium-carboxylate initiated copolymerization of epoxides and CO₂ for the direct synthesis of polycarbonate diols and polyols. The preparation of polycarbonate diols and polyols was also performed using multifunctional tetrabutylammonium carboxylate initiators in the presence of their corresponding multifunctional protic compounds such as water, multifunctional alcohols, acids, etc.

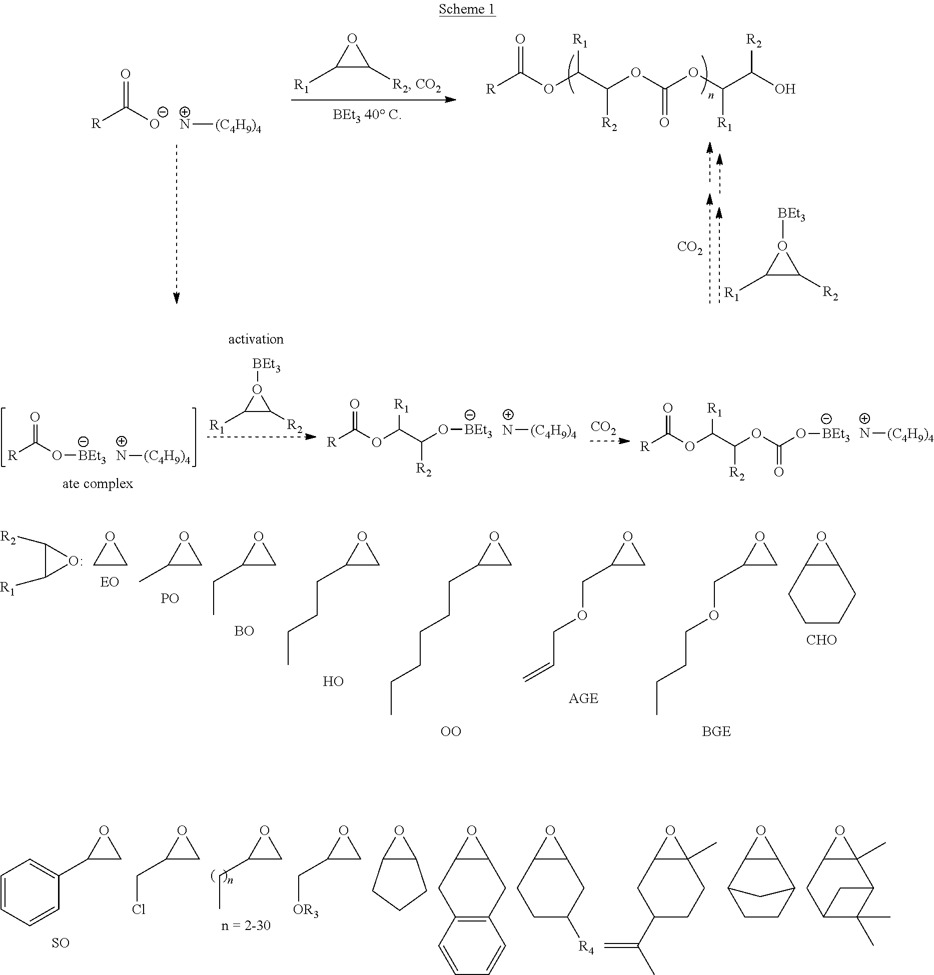

### EXAMPLE 2

### Mechanism for Initiations Involving Protic Compounds

Scheme 2, also provided below, is a schematic representation of a proposed mechanism for initiations involving protic compounds. Upon changing the polymerization conditions, feeding ratio of monomer to the initiator, borane to the initiator, and charged pressure of carbon dioxide, the molar mass (1000 to 10000 g/mol) and carbonate content was easily tuned.

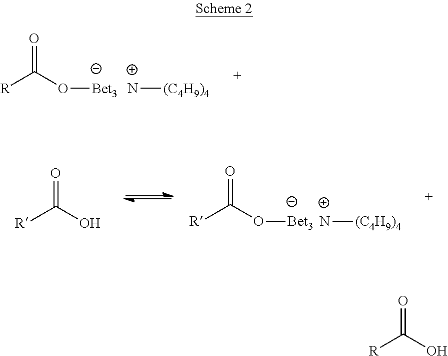

### EXAMPLE 3

### Representative Multi-Functional TBA Carboxylate Salts

The carboxylate salt initiators were either aliphatic or aromatic compounds, carrying different functionalities. See Scheme 3 provided below, which is a schematic representation of representative multi-functional tetrabutylammonium carboxylate salts for the preparation of polycarbonate polyols.

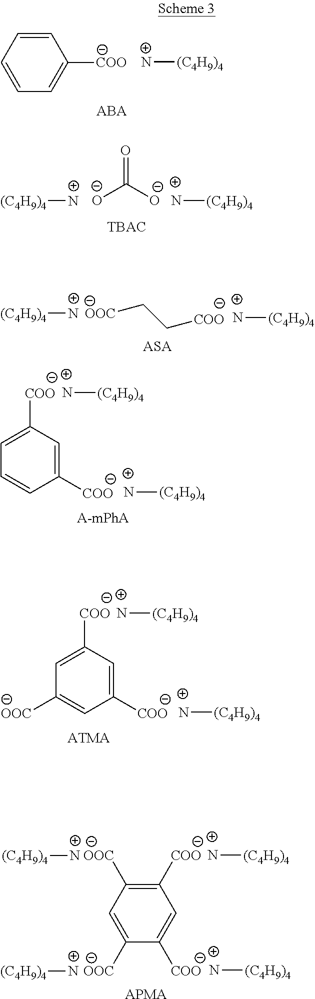

### EXAMPLE 4

### Synthesis of Tetrabutylammonium Carbonate (TBAC)

The TBAC was prepared as follows: In a Schleck flask, an aqueous solution of tetrabutylammonium hydroxide (about 20 mL) was stirred under a positive pressure of CO₂ and the reaction was followed by phenolphthalein indicator until the disappearance of the pink color was observed. The water was removed by lyophilization. Further traces of water was removed by lyophilization with anhydrous 1,4 dioxane to get TBAC as a white powder.

### EXAMPLE 5

### General Procedure for Synthesis of Tetrabutylammonium Salt of Carboxylic Acid

In a Schlenk tube, an aqueous solution of tetrabutylammonium hydroxide was charged under argon. An equivalent quantity of carboxylic acid was added and stirred at about 25° C. for about 1 h. The completion of neutralization reaction was monitored by phenolphthalein indicator. The water was removed by lyophilization. Further traces of water was removed by lyophilization with anhydrous 1,4 dioxane to get the corresponding ammonium carboxylate salt as a white powder.

### EXAMPLE 6

### Preparation of Poly(Propylene Carbonate) Diol

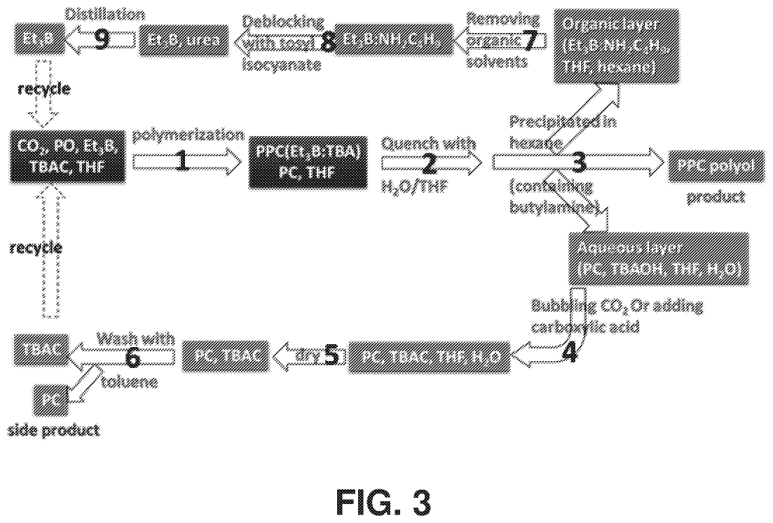

A typical experimental procedure, corresponding to entry 4, is described below. A 50 mL Parr reactor with a magnetic stir bar and a small glass vial inside was first dried in an oven at about 120° C. overnight and then immediately placed into a glove box chamber. After keeping under vacuum for about 2 hours, the reaction vessel was moved into the glove box under argon atmosphere. The reactor was charged with difunctional initiator (about 0.2 g, about 0.367 mmol), triethyl borane (about 1.03 mL, about 1 Molar solution in THF, about 1.03 mmol), and THF (about 1.0mL). The propylene oxide (about 2.05 mL, about 29.3 mmol) was then added in the glass vial inside the reactor, the reactor was quickly sealed, taken out from the glove box and charged with CO₂ to a pressure of about 10 bar and reaction was carried out at about 40° C. for about 14 h with stirring. The work up process was followed the procedure as shown in FIG. 3. The reactor was cooled, the unreacted CO₂ was slowly released, and the polymer solution was firstly quenched with about 1 mL of deoxygenated deionized water dissolved butyl amine (1.03 mmol) and dicarboxylic acid (0.367 mmol) or bubbling CO₂ and stirred for about 10 min. The whole solution was precipitated in hexane. The solution of organic layer and aqueous layer was separated for recycling ammonium initiator and triethylborane, respectively. The crude product at the bottom (if needed) was further diluted with tetrahydrofuran and precipitated again in water. The product was collected and dried in vacuum at about 40° C.

### EXAMPLE 7

### Process of Recycling Activator and/or Initiator

The process of polycarbonate polyols isolation allowed recycling of the ammonium initiators and trialkylborane as shown in FIG. 3, which, in addition to being metal-free, is at least one advantage over other conventional polymerization systems, methods, etc. As shown in FIG. 3, propylene oxide, triethylborane, and tetrabutylammonium carbonate were used an example of epoxides, activators, and ammonium initiators, respectively. The initiator was recovered and isolated as tetrabutylammonium carbonate or carboxylates upon treatment with CO₂ or carboxylic acids. As for triethylborane, after formation of complex with amine, it was extracted into an organic layer. Then the borane complex was deblocked with isocyante, the freed triethylborane was then recovered through distillation. In the examples described below the amount of ammonium carbonate used in the first experiment could be fully recovered (100%) after each further attempt to initiate the copolymerization of CO₂ with epoxides. It was therefore demonstrated that ammonium hydroxide could be indefinitely recovered experiment after experiment. The triethylborane on the other hand was quantitatively extracted from the polymerization mixture.

### EXAMPLE 8

### Recycling Tetrabutylammonium Initiator

As shown in FIG. 3, the aqueous layer obtained after precipitation of PPC diol which contain the initiator due to neutralization with bubbling CO2 or through the addition of equal equivalent carboxylic acids to transfer the ammonium into salts (e.g., carbonate salts). The solution was further evaporated and dried. After removing the high boiling point side compound propylene carbonate by washing with toluene, the recovered tetrabutylammonium salts could be put into next cycle for polymerization.

### EXAMPLE 9

### Recycling Triethylborane

The hexane layer obtained above was subjected to distillation to remove hexane, THF and excess butyl amine if any. The distillation residue containing TEB-butylamine adduct was dissolved in dry THF (about 3 mL). To that formed solution was added tosyl isocyanate (about 1.0 eq., about 0.156 mL, about 0.186 g, about 1.0 mmol). Then the isocyanate solution was subjected to distillation (about 40-80° C.) under static reduced pressure; the distillation residue was again dissolved in about 1.5 mL of dry THF and redistilled under the same condition to recover TEB completely from the viscous isocyanate residue. Triethylborane together with THF was collected and found the recycling yield to be about 71% (using naphthalene as internal standard).

### EXAMPLE 10

### Tables 1 and 2

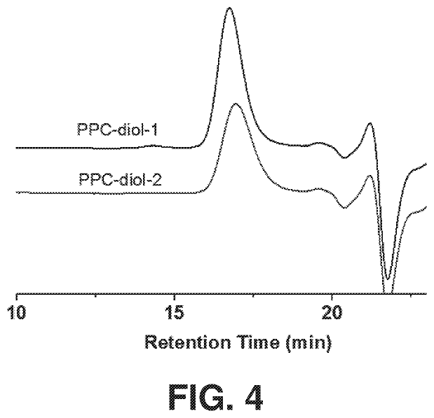

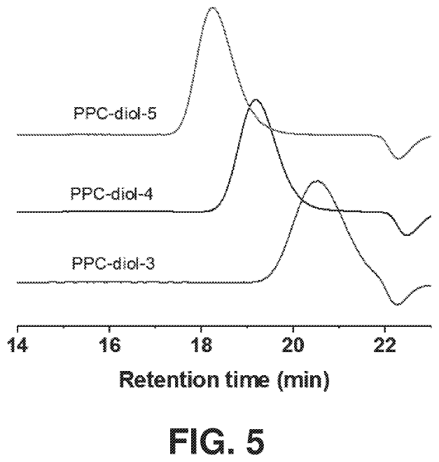

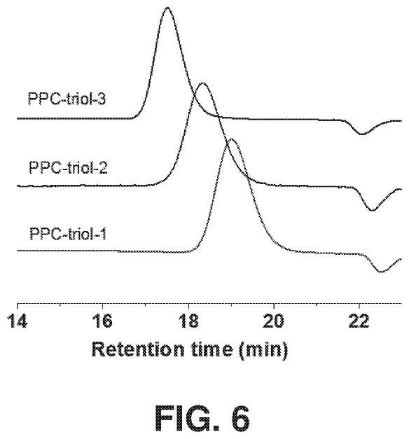

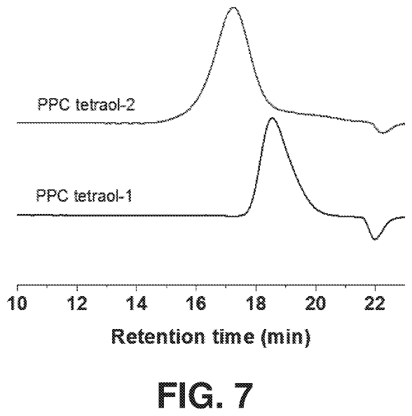

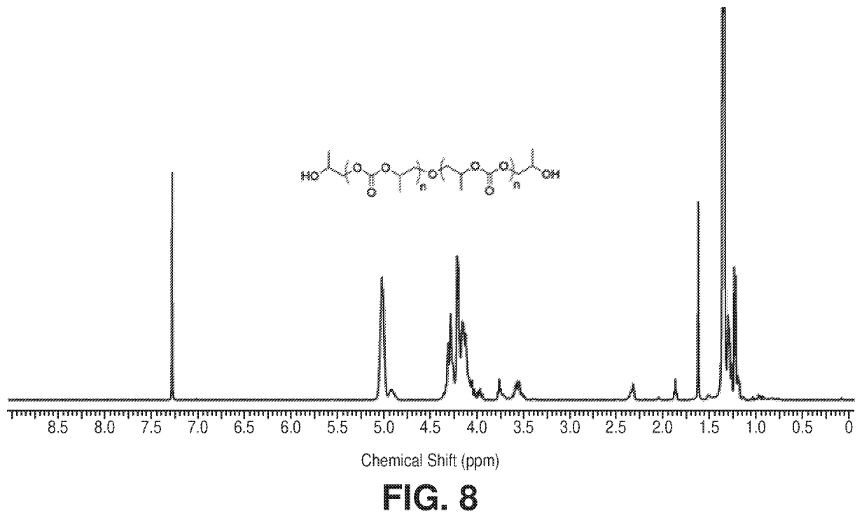

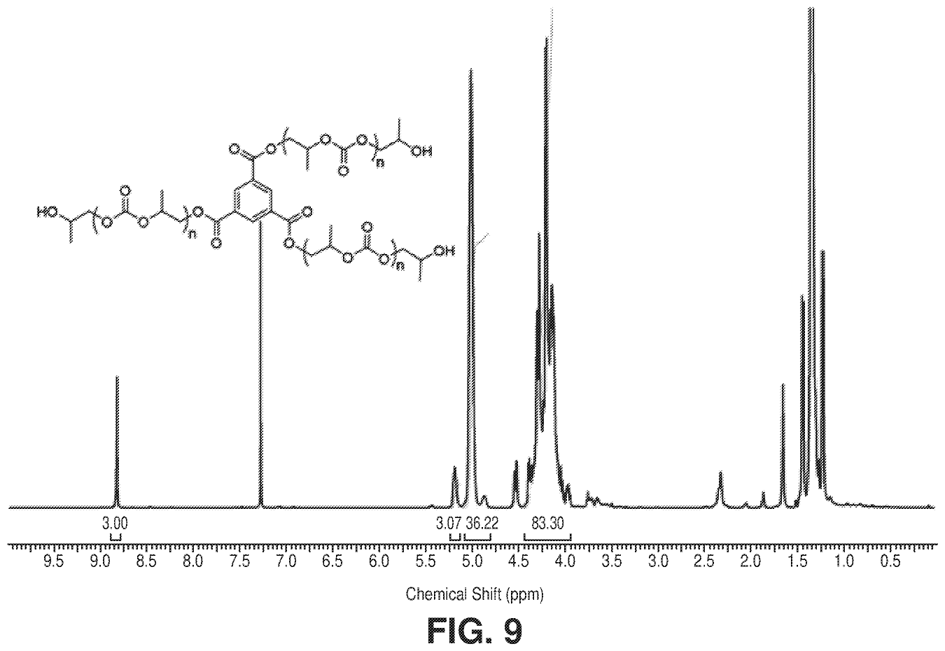

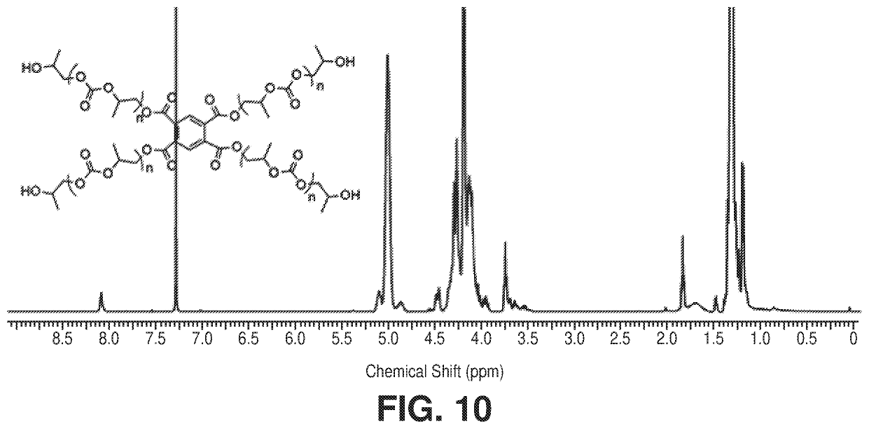

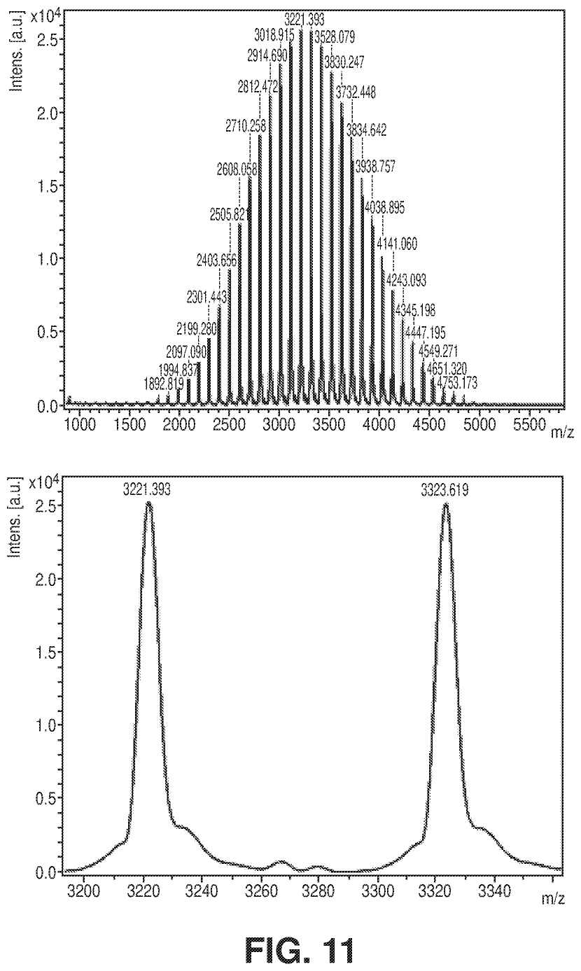

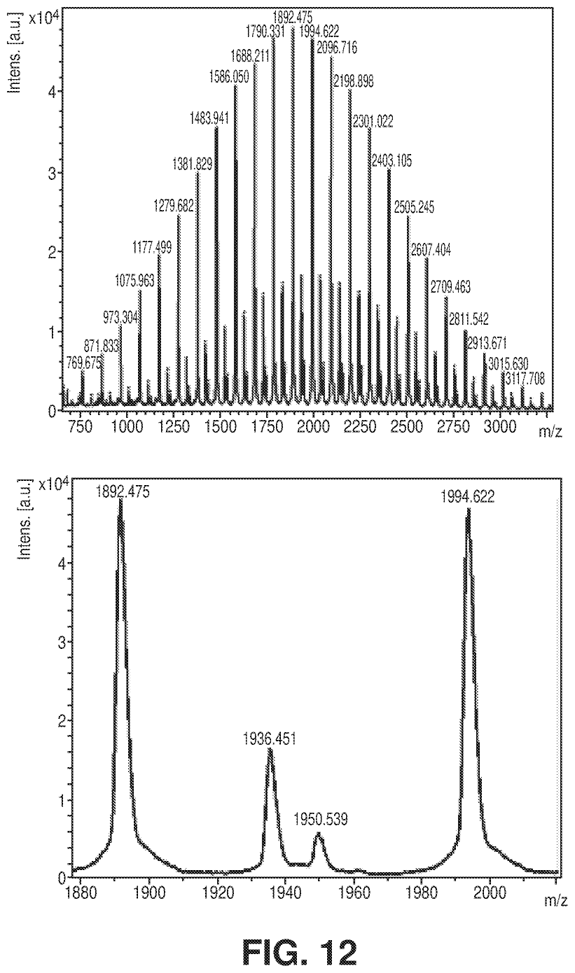

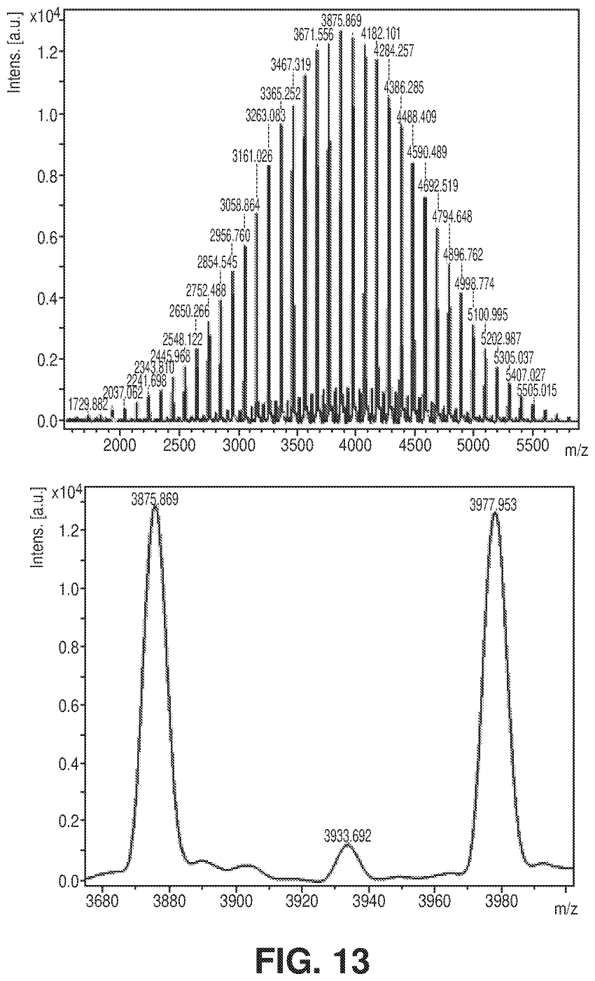

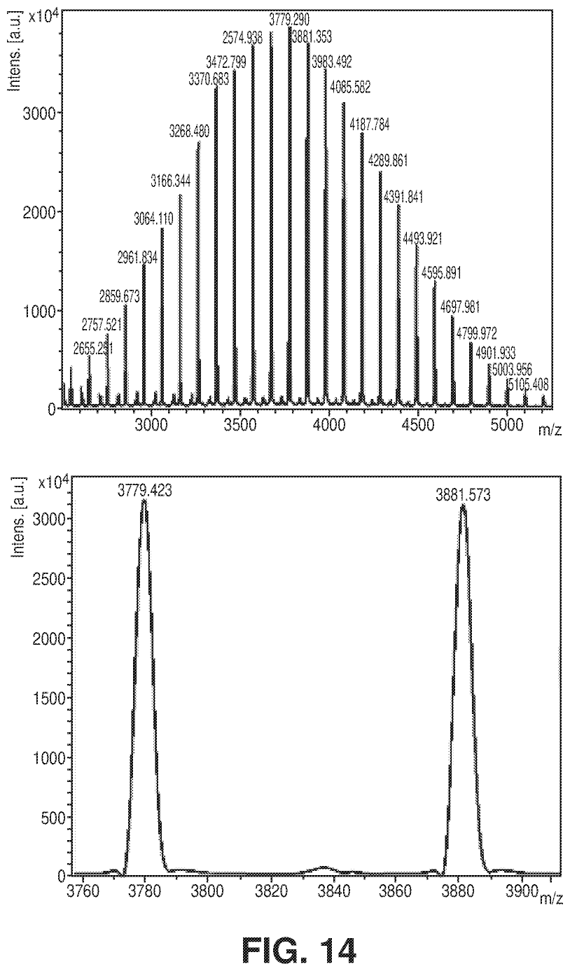

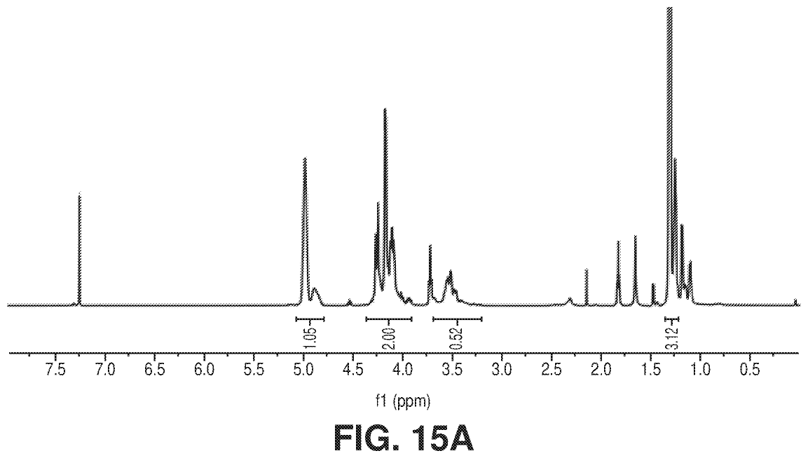

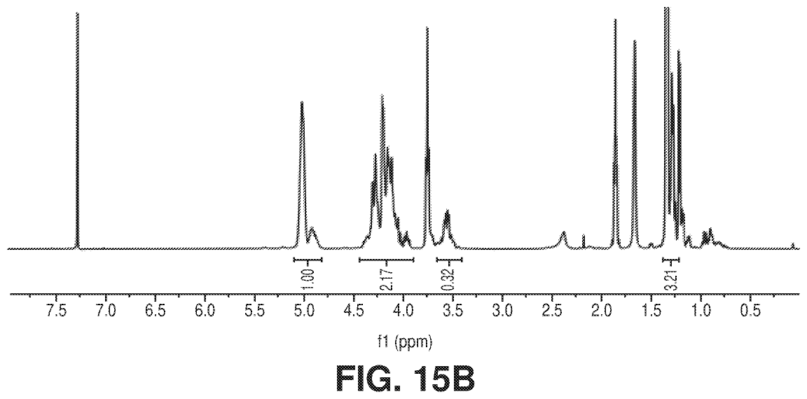

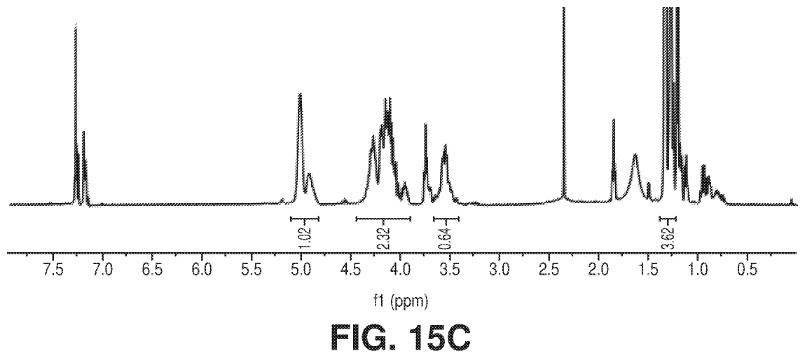

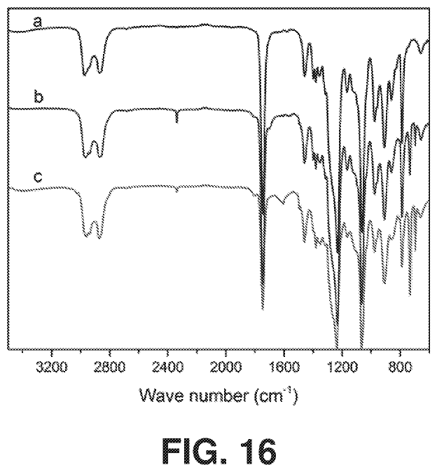

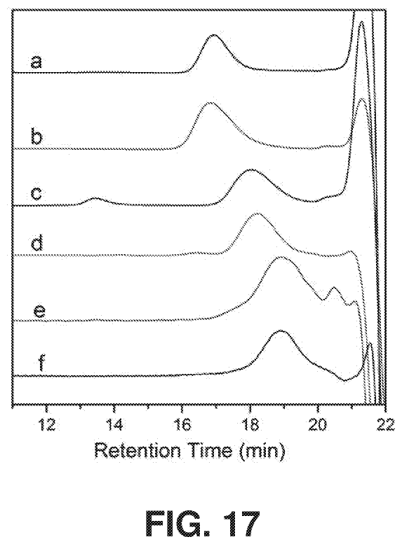

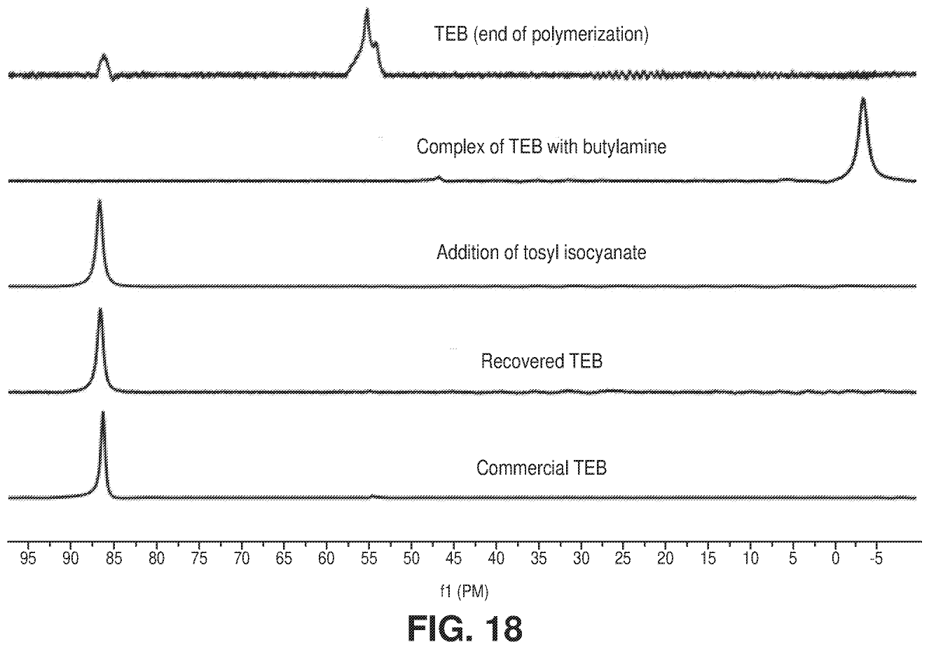

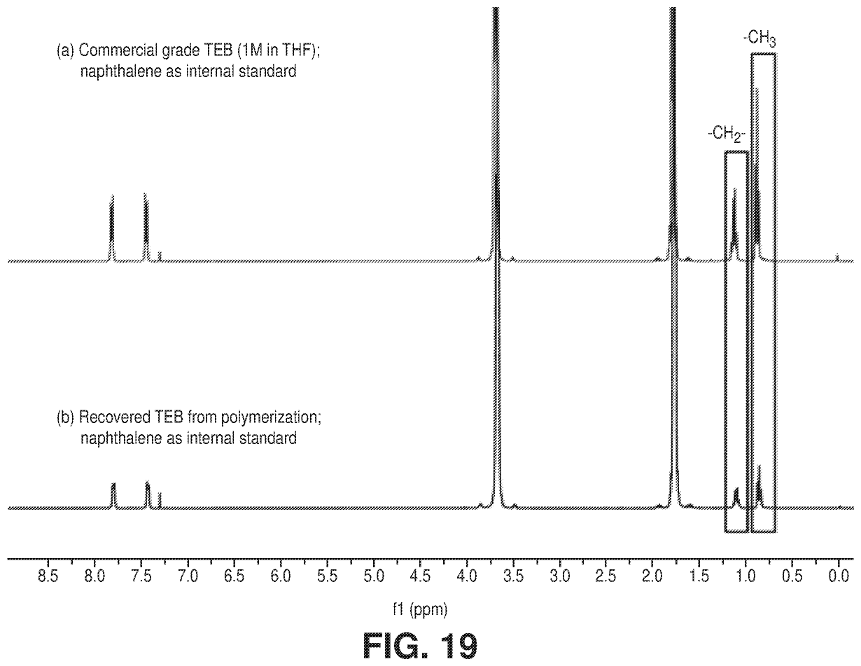

See Tables 1 and 2 presented below provide the experimental results. In addition, representative GPC traces are provided in FIGS. 4-7. Representative ¹H NMR spectra are provided in FIGS. 8-10. Representative MALDI-TOF characterization results are provided in FIGS. 11-14. Representative ¹H NMR spectra of PPC-diols having varying carbonate content are provided in FIGS. 15A-15C. Representative FTIR spectra of PPC-diol samples are provided in FIGS. 16A-16C. Representative GPC traces of PPC-diol samples from Table 2 are provided in FIGS. 17A-17F. FIG. 18 shows ¹¹B NMR evolution of triethylborane state during its recycling process. FIG. 19 shows a ¹H NMR characterization and quantification of recycled triethylborane using naphthalene as internal standard.

TABLE 1
Triethyl borane assisted copolymerization of propylene oxide and carbon dioxide

| | | | Selectivity | PC | Yield | M_{n(NMR)} | M_{n(GPC)}^{f} |
|---|---|---|---|---|---|---|---|
| Entry | Initiator | [M]:[I]:[A] | (%)^{b} | (%)^{c} | (%)^{d} | (10³)^{e} | (10³)/Ð |
| 1 | ABA | 500:1:2 | >99 | 95 | 43 | 19.0 | 16.8/1.1 |
| 2 | ASA | 40:1:4.0 | 95 | 63 | 92 | 3.6 | 3.5/1.2 |
| 3 | ASA | 40:1:3.0 | 92 | 80 | 90 | 3.7 | 3.9/1.1 |
| 4 | ASA | 40:1:2.0 | 92 | 98 | 95 | 3.9 | 4.3/1.1 |
| 5 | A-mPhA | 40:1:2.0 | 98 | 98 | 96 | 4.2 | 5.0/1.1 |
| 6 | TBAC | 40:1:2.8 | 95 | 91 | 93 | — | 4.1/1.1 |
| 7 | TBAC | 10:1:2.8 | >99 | 88 | 95 | — | 1.1/1.4 |
| 8 | TBAC | 20:1:2.8 | >99 | 93 | 96 | — | 2.1/1.2 |
| 9 | TBAC | 80:1:2.8 | 93 | 96 | 95 | — | 7.3/1.1 |
| 10 | TBAC | 100:1:2.8 | 95 | 99 | 90 | — | 9.2/1.1 |
| 11^{g} | TBAC | 40:1:2.8 | >99 | 91 | 90 | — | 3.7/1.1 |
| 12^{h} | TBAC | 40:1:2.8 | 95 | 53 | 90 | — | 3.4/1.1 |
| 13 | ATMA | 40:1:3.0 | >99 | 99 | 96 | 4.3 | 4.6/1.1 |
| 14 | ATMA | 60:1:3.0 | 95 | 99 | 95 | 5.5 | 6.6/1.1 |
| 15 | ATMA | 100:1:3.0 | 96 | 99 | 94 | 9.3 | 9.3/1.0 |
| 16 | APMA | 40:1:3.6 | 98 | 97 | 95 | 4.8 | 4.2/1.1 |
| 17 | APMA | 60:1:3.6 | 94 | 98 | 94 | 6.2 | 5.6/1.1 |
| 18 | TBAC | 50/0.7/ | >99 | 95 | 72 | 3.7 | 2.5/1.2 |
| | | 0.3(H₂O)/3.5 | | | | | |
| 19 | TBAC | 50/0.7/ | >99 | 92 | 75 | 3.8 | 2.5/1.2 |
| | | 0.3(H₂O)/5.0 | | | | | |
| 20 | TBAC | 50/0.8/ | >99 | 91 | 82 | 4.2 | 2.9/1.2 |
| | | 0.2(H₂O)/5.0 | | | | | |
| 21 | ASA | 40/1/ | 76 | 96 | 76 | 2.9 | 2.5/1.1 |
| | | 0.3(H₂O)/2.2 | | | | | |

^{a}Polymerizations were carried out in 50 mL Parr reactor under 10 bar CO₂ with stirring at 40° C.
^{b,c}Determined from ¹H NMR of crude product.
^{d}Calculated by gravimetry.
^{e}M_{n(NMR)} was calculated based NMR data.
^{f}Determined by GPC with THF as eluent and calibrated by polystyrene standard.
^{g}under 2 bar of CO₂.
^{h}under 1 atmosphere CO₂ in glass reactor.

TABLE 2
Recycling of ammonium initiator from TBAC for PPC-diol synthesis^{a}

| | Initiator | | | Selectivity | | Yield | M_{n(Theo)}^{e} × | M_{n(GPC)}^{f} × |
|---|---|---|---|---|---|---|---|---|
| Entry | TBAC | [M]:[I]:[A] | Time (h) | (%)^{b} | PC (%)^{c} | (%)^{d} | 10³ | 10³/PDI |
| 1 | Fresh | 50:1:3.5 | 14 | 93 | 91 | 66 | 3.3 | 3.0/1.1 |
| 2 | Recycle I | 50:1:3.5 | 5 | 94 | 85 | 59 | 2.9 | 2.8/1.3 |
| 3 | Recycle II | 50:1:3.5 | 7 | >99 | 91 | 52 | 2.6 | 2.7/1.2 |
| 4 | Fresh | 20:1:3.5 | 16 | 85 | 84 | 69 | 1.4 | 1.6/1.5 |
| 5 | Recycle I | 20:1:3.5 | 14 | 98 | 85 | 71 | 1.4 | 1.6/1.3 |
| 6 | Recycle II | 20:1:3.5 | 14 | 91 | 91 | 73 | 1.5 | 1.4/1.4 |
| 7 | Recycle III | 20:1:3.5 | 20 | 95 | 87 | 74 | 1.5 | 1.6/1.3 |
| 8 | Fresh | 10:1:3.5 | 14 | >99 | 93 | 46 | 0.5 | 0.8/1.5 |
| 9 | Recycle I | 10:1:3.5 | 14 | 95 | 79 | 43 | 0.4 | 0.8/1.8 |
| 10 | Recycle II | 10:1:3.5 | 20 | 97 | 82 | 50 | 0.5 | 0.9/1.6 |

^{a}All polymerizations were carried out in 50 mL autoclaves under 10 atm of CO2;
^{b}Selectivity of linear carbonate calculated from IR spectra;
^{c}determined from ¹H NMR;
^{d}Calculated by gravimetry;
^{e}Calculated based on the formula: Mn(theo) = 102 (DPtarget) × (yield %).
^{f}Determined by GPC in THF with polystyrene standard.

Other embodiments of the present disclosure are possible. Although the description above contains much specificity, these should not be construed as limiting the scope of the disclosure, but as merely providing illustrations of some of the presently preferred embodiments of this disclosure. It is also contemplated that various combinations or sub-combinations of the specific features and aspects of the embodiments may be made and still fall within the scope of this disclosure. It should be understood that various features and aspects of the disclosed embodiments can be combined with or substituted for one another in order to form various embodiments. Thus, it is intended that the scope of at least some of the present disclosure should not be limited by the particular disclosed embodiments described above.

Thus the scope of this disclosure should be determined by the appended claims and their legal equivalents. Therefore, it will be appreciated that the scope of the present disclosure fully encompasses other embodiments which may become obvious to those skilled in the art, and that the scope of the present disclosure is accordingly to be limited by nothing other than the appended claims, in which reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present disclosure, for it to be encompassed by the present claims. Furthermore, no element, component, or method step in the present disclosure is intended to be dedicated to the public regardless of whether the element, component, or method step is explicitly recited in the claims.

The foregoing description of various preferred embodiments of the disclosure have been presented for purposes of illustration and description. It is not intended to be exhaustive or to limit the disclosure to the precise embodiments, and obviously many modifications and variations are possible in light of the above teaching. The example embodiments, as described above, were chosen and described in order to best explain the principles of the disclosure and its practical application to thereby enable others skilled in the art to best utilize the disclosure in various embodiments and with various modifications as are suited to the particular use contemplated. It is intended that the scope of the disclosure be defined by the claims appended hereto

Various examples have been described. These and other examples are within the scope of the following claims.

1. A polymerization system for the synthesis of polycarbonate polyols, comprising:
an initiator including a mono- or multi-functional carboxylate or carbonate salt having an organic cation as a counter-ion, where the organic cation includes monomeric, polymeric attached to polymer and solid supporting material;
an optional co-initiator including a mono- or multi-functional protic compound selected from acids, alcohols, water, and combinations thereof; and
an activator including a borane compound selected from alkyl boranes and aryl boranes;
wherein the activator and one or more of the initiator and co-initiator associate to form an ate complex.

2. The system according to claim 1, wherein the initiator is represented by one of the following formulas: {R¹—[C(═O)O⁻]_{y}, [X⁺]_{y}} and {C(═O)(O⁻)_{y}, [X⁺]_{y}}, wherein R¹ is selected from aliphatic hydrocarbons and aromatic hydrocarbons, wherein X⁺ is selected from ammoniums, phosphoniums, and phosphazeniums.

3. The system according to claim 1, wherein the X⁺ is selected from NBu₄⁺, NOct₄⁺, NPh₄⁺, PBu₄⁺, PPh₄⁺, PPN⁺, t-BuP₄^{+,} and t-BuP₂⁺.

4. The system according to claim 1, wherein the initiator is selected from one or more of the following:

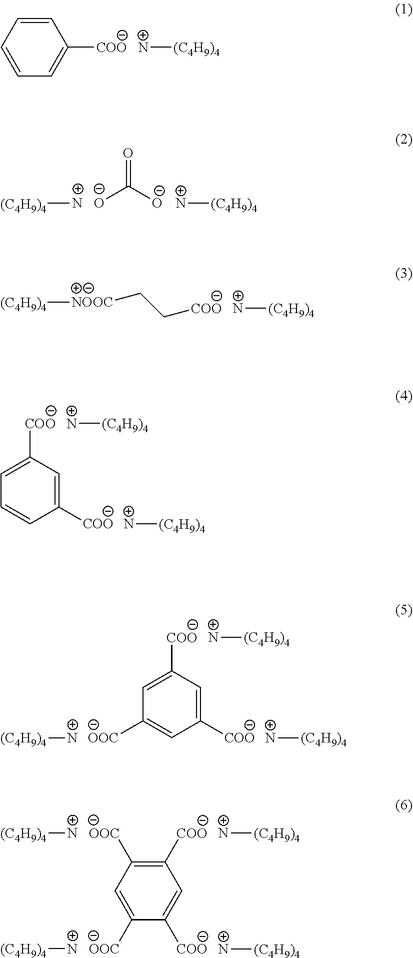

5. The system according to claim 1, wherein the optional co-initiator is a multifunctional protic compound comprising at least two moieties independently selected from —OH, —SH, —C(O)OH, and —NH.

6. The system according to claim 1, wherein the optional co-initiator is selected from sulfonic acids, carboxylic acids, adducts of boric acid, glycols, salicylic acids, methanol, ethanol, propanol, butanol, and water.

7. The system according to claim 1, wherein the borane compound has the formula: B(R²)_{z}, wherein z is 1 to 3 and each R² is independently selected from alkyls and aryls.

8. The system according to claim 1, wherein the borane compound is provided in molar excess of the initiator and/or co-initiator.

9. A method of synthesizing a polycarbonate polyol, comprising:
contacting an epoxide monomer and carbon dioxide in the presence of a polymerization system to form a crude polycarbonate product in solution,
wherein the polymerization system comprises an initiator including a mono- or multi-functional carboxylate or carbonate salt of tetrabutylammonium, an optional protic compound, and a borane compound; and
precipitating a polycarbonate polyol product out of the solution.

10. The method according to claim 9, wherein the initiator has been recovered and recycled from a prior synthesis.

11. The method according to claim 9, wherein the epoxide monomer is selected from:

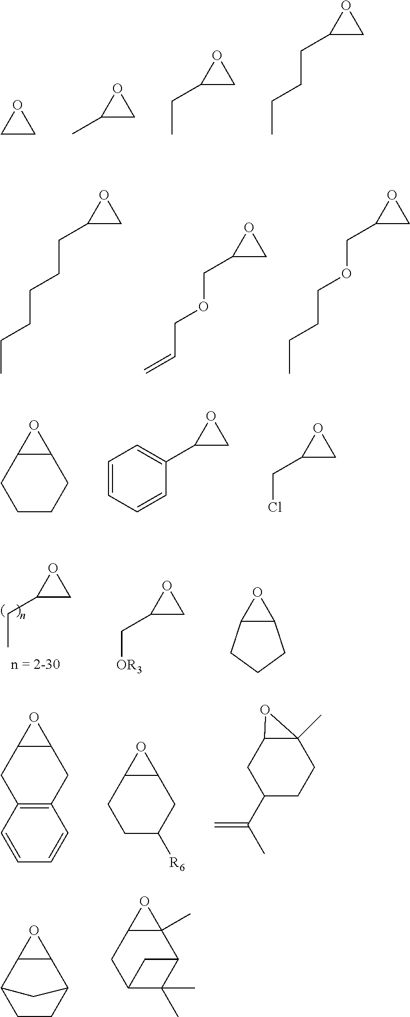

12. The method according to claim 9, wherein the polycarbonate polyol product is precipitated in water.

13. The method according to claim 9, wherein the polycarbonate polyol product is precipitated in acidic water or neutral water.

14. The method according to claim 9, wherein the molar mass and/or carbonate content of the polycarbonate polyol product can be tuned by varying one or more of the feeding ratio of epoxide monomer to the initiator, borane compound to the initiator, and charging pressure of the carbon dioxide.

15. A method of recovering an activator and initiator from a solution for use or re-use in the synthesis of polycarbonate polyols, the method comprising:
quenching a polymer solution containing a crude polycarbonate with a solution comprising a Lewis base and Lewis acid in water, said crude polycarbonate having an activator-organic cation complex at a chain end;
reacting the organic cation with an anion to form an initiator that is extracted into a first layer;
reacting the activator with a Lewis base to form an activator-Lewis base complex that is extracted into a second layer, said second layer being immiscible with said first layer;
separating the first layer from the second layer;
contacting the second layer with an isocyanate compound to disassociate the activator from the Lewis base and processing the second layer to recover the activator; and
contacting the first layer with a non-solvent to separate the initiator from the polymer and processing the first layer to recover the initiator.

16. The method according to claim 15, wherein the Lewis base is a primary or secondary amine.

17. The method according to claim 15, wherein the Lewis base is selected from butylamine, pentylamine, hexylamine, diethylamine, dipropylamine, and dibutylamine.

18. The method according to claim 15, wherein the Lewis acid is selected from water, carbon dioxide, carboxylic acids, alcohols, phenols, carbonates, and halogens.

19. The method according to claim 15, wherein the Lewis acid is a selected from: water, carbon dioxide, methanol, ethanol, propanol, butanol, hexanol, benzyl alcohol, formic acid, acetic acid, propionic acid, butyric acid, valeric acid, caproic acid, pentanoic acid, caprylic acid, pelargonic, carbonic acid, oxalic acid, malonic acid, succinic acid, glutaric acid, adipic acid, p-Mer acid, suberic acid, azelaic acid, sebacic acid, methyl succinic acid, 2,2-dimethyl succinic acid, 2,3-dimethylsuccinic acid, methylmalonic acid, α-methyl glutaric acid, β-methyl glutaric acid, 2,2-dimethyl glutaric acid, 2,4-dimethyl glutaric acid, 3,3-dimethyl glutaric acid, 2-ethyl-2-methyl succinic acid, 2,2,5,5-tetramethyl-hexanoic acid, 3-methyl adipic acid, acrylic acid, crotonic acid, isocrotonic acid, vinyl acetate, methacrylic acid, fumaric acid, maleic acid, methyl maleic acid, methyl fumaric acid, itaconic acid, citraconic acid, mesaconic acid, glutaconic acid, non-acid, 2-methyl-non-acid, acetylene dicarboxylic acid, oxalic acid, malonic acid, succinic acid, glutaric acid, adipic acid, pimelic acid, suberic acid, azelaic acid, sebacic acid, undecanedioic acid, dodecanedioic acid, 1-propyn-1,3-dicarboxylic acid, methane tricarboxylic acid, ethylene tricarboxylic acid, citric acid, isocitric acid, aconitic acid, propane-1,2,3-tricarboxylic acid, trimesic acid, cyclohexanecarboxylic acid, kolran acid, lithocholic acid, cholic acid, 1,2-cyclohexanedicarboxylic acid, 1,3 -cyclohexanedicarboxylic acid, 1,4-cyclohexanedicarboxylic acid, 3,3-tetramethylene glutaric acid, benzoic acid, toluic acid, kumsan, phthalic acid, isophthalic acid, terephthalic acid, carbonic acid, carbonate esters, phenol, hydrogen chloride, hydrogen bromide, hydrogen iodide, hydrogen fluoride, derivatives thereof, and combinations thereof.

20. The method according to claim 15, wherein the water and Lewis acid form a quenching agent.

21-29. (canceled)
